(19) United States
(12) Patent Application Publication
(10) Pub. No.: US 2022/0321831 A1
(43) Pub. Date: Oct. 6, 2022

(54) WHITEBOARD USE BASED VIDEO CONFERENCE CAMERA CONTROL

(71) Applicant: Lenovo (Singapore) Pte. Ltd., Singapore (SG)

(72) Inventors: Scott Wentao Li, Cary, NC (US); Robert J. Kapinos, Durham, NC (US); Robert James Norton, JR., Raleigh, NC (US); Russell Speight Vanblon, Raleigh, NC (US)

(21) Appl. No.: 17/220,297

(22) Filed: Apr. 1, 2021

(51) Int. Cl. H04N 7/15; G06T 7/70; G06K 7/14; G06K 9/00; G06K 9/62; H04N 5/232; G06F 3/14

(52) U.S. Cl. CPC H04N 7/15; G06T 7/70; G06K 7/1417; G06K 9/00362; G06K 9/00624; G06K 9/6215; H04N 5/23238; G06F 3/1454; G06T 2207/30204

(57) ABSTRACT

A computer implemented method includes receiving an image of a room having a drawing surface via a video conference camera, decoding a code associated with the drawing surface to derive a location of the code with respect to the drawing surface and identification of a boundary of the drawing surface with respect to the code, detecting activity with respect to the drawing surface, and providing a video feed including a view of the drawing surface via the video conference camera in response to the activity.

### BACKGROUND

Video conferencing systems may utilize a 360-degree conference camera to capture images of a conference room during a conference. Many such cameras may be controlled by the video conferencing system to zoom in and focus on a person that is speaking. The video conference system may use may different available sensing mechanisms to identify the person speaking, such as sound location, video image recognition, or combinations thereof. The controlled focus can provide a better experience for remote conference participants who are not in the room, as they are provided an image of the person in the conference room while the person is speaking.

### SUMMARY

A computer implemented method includes receiving an image of a room having a drawing surface via a video conference camera, decoding a code associated with the drawing surface to derive a location of the code with respect to the drawing surface and identification of a boundary of the drawing surface with respect to the code, detecting activity with respect to the drawing surface, and providing a video feed including a view of the drawing surface via the video conference camera in response to the activity.

### BRIEF DESCRIPTION OF THE DRAWINGS

FIG. 1 is a top view representation of a conference room having a video conferencing system with camera according to an example embodiment.

FIG. 2 is a block representation of a whiteboard having a whiteboard identification code shown in an upper left corner of the whiteboard according to an example embodiment.

FIG. 3 is a display device showing a visual representation of an ongoing video conference video feed involving a video conference room with a video conferencing system according to an example embodiment.

FIG. 4 is a flowchart illustrating a computer implemented method of controlling the camera to provide images of a drawing surface according to an example embodiment.

FIG. 5 is a block diagram representation of an example rendered video feed view of a whiteboard that includes a person proximate the whiteboard according to an example embodiment.

FIG. 6 is a view of a rendered video feed that includes a whiteboard in one window plus a mosaic view of meeting participants according to an example embodiment.

FIG. 7 is a view of a QR code having an empty middle portion for drawing or otherwise placing system recognizable commands according to an example embodiment.

FIG. 8 is a flowchart illustrating a computer implemented method of specifying and executing commands according to an example embodiment.

FIG. 9 is a flowchart illustrating a computer implemented method of specifying and executing user configurable commands according to an example embodiment.

FIG. 10 is a flowchart illustrating a computer implemented method of detecting activity with respect to a drawing surface according to an example embodiment.

FIG. 11 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Existing video conferencing systems equipped with a 360 degree conference camera can automatically highlight and shift focus to different people in the room in response to detecting people who are speaking. While such 360 degree conference systems can enhance some meeting experiences, the use of whiteboards or other drawing surfaces in a conference room are not easily shared with remote users. Drawing surfaces can be integral part of face to face meetings, as they are typically used to illustrate the subject matter of meetings.

In various embodiments of the present inventive subject matter, a code or other symbol is used to identify a writing surface in a conference room. The code may be a QR code, bar code, or even a graphical symbol. The drawing surface may be a whiteboard, flipchart, or other type of surface on which writing or drawing may be captured and displayed by a video conference system having a camera.

Information included in or associated with the symbol is used to define a boundary of the drawing surface. The video conferencing system camera captures one or more images of a conference room, including the drawing surface. The information is obtained based on the code to identify the boundary of the drawing surface. Use of the drawing surface, or the presence of a person, such as an attendee indicative of impending use of the drawing surface causes the video conferencing system to control the camera to provide images of the drawing surface for a video conferencing feed. The video conferencing feed thus includes the drawing surface and optionally images of attendees that are speaking.

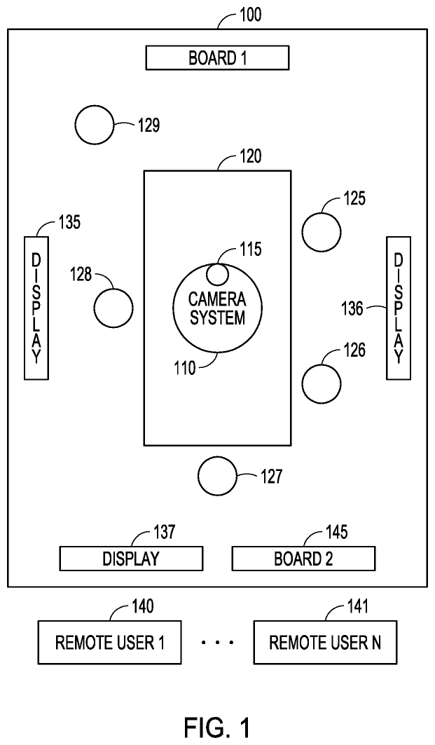

FIG. 1 is a top view representation of a conference room 100. A video conferencing system 110 with camera 115 is disposed in the conference room 100 such as on a conference table 120. The camera 115 may have one or more lenses and corresponding video capturing capabilities to provide a 360-degree view of the room 100. The system 110 and camera 115 generates a video feed of an on-going video conference.

Several meeting attendees, such as users, 125, 126, 127, 128, and 129 are shown in the room at various positions around the room. Users 125, 126, 127, 128 are shown seated at the table 120. User 129 is shown near a drawing surface 130. The drawing surface may be a whiteboard, chalkboard, flip chart, paper hung on a wall, electronic drawing surface, or any other surface capable of being drawn upon for viewing by attendees.

Room 100 may also include one or more displays 135, 136, and 137 for viewing by users in the room. Displays 135, 136, and 137 may be used to display images of remote users indicated at 140 and 141 or images of the video feed generated by the video conferencing system 110 and camera 115. Remote users 140 and 141 are also representative of computing equipment enabling the remote users 140 and 141 to view images of the video conference feed, both those generated by camera 115 as well as from other devices connected to a conferences, such as devices 140 and 141. A second drawing surface, whiteboard 145 may also be included in the room 100.

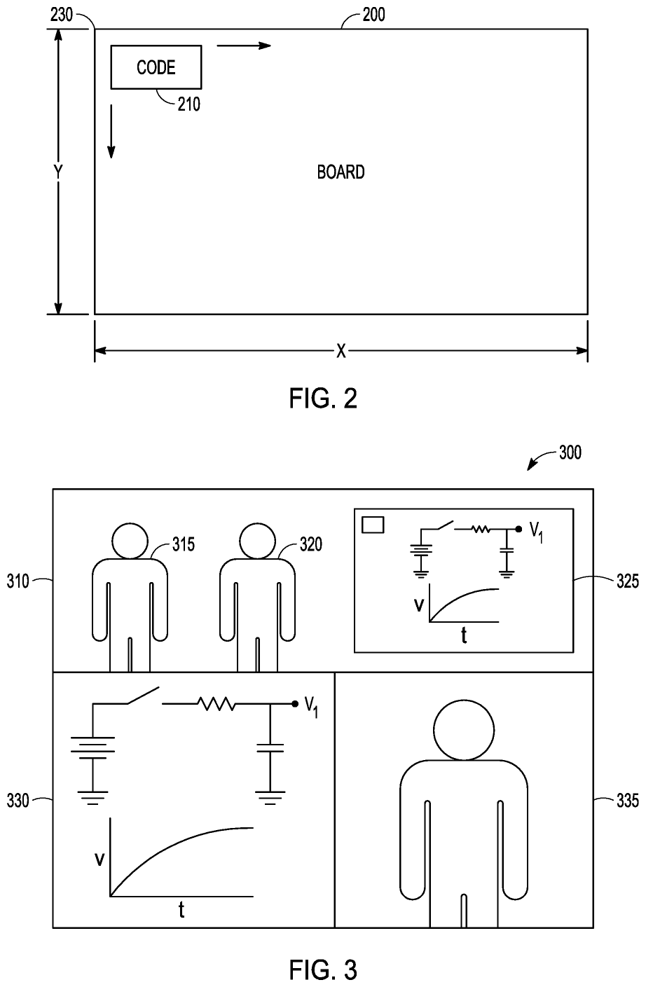

FIG. 2 is a block representation of a whiteboard 200 having a code 210 shown in an upper left corner of the whiteboard 200. Whiteboard 200 is a writing surface having dimensions of X and Y. The code 210 is recognizable via image processing and identifies information related to the whiteboard 200. The code may encode the actual information or may act as a pointer to the information. In further embodiments, the code may also identify a name or label of the whiteboard, such as south whiteboard, or whiteboard number one in conference room 20-203 for example. The name or label may be added to a video that includes a view of the whiteboard 200.

In one embodiment, the code 210 operates as an anchor point, and the identified information includes vectors 215 and 220. Vector 215 operates to identify the X dimension of the whiteboard 200, and vector 220 operates to identify the Y dimension of the whiteboard 200 from the position of the code 210 or anchor point. Each vector represents a direction and distance. The code 210 may also identify an origin of the 230 of a coordinate system corresponding to the upper left extent of the whiteboard.

The code 210 may be placed anywhere on or near the whiteboard 200, as specifying the origin 220 and vectors 215 and 220 adequately defines the boundaries of the whiteboard 200 for rectangular whiteboards. The code may be placed or attached proximately the whiteboard 200 by adhesive, magnet, or other means. Other shapes of whiteboards may be identified via equation or multiple further sets of vectors corresponding to points around the boundary from which interpolation between points may be used to adequately represent the boundary of the whiteboard. The code thus allows a camera to be controlled to capture the whiteboard in images/video added to the video conference video feed for display to remote users and one or more of the displays in the conference room if desired. The whiteboard images may be zoomed to show the entire whiteboard or the whiteboard and an attendee using the whiteboard in various embodiments.

FIG. 3 is a display device 300 showing a visual representation of an ongoing video conference video feed involving a video conference room with a video conferencing system as described herein. A window 310 shows a panorama view of the conference room including two attendees 315 and 320, as well as a whiteboard 325. A larger window 330 is a zoomed in view of the whiteboard. A further window 335 shows one of the users in a larger format. The window 330 may be displayed as the result of activity occurring near the whiteboard, or upon detection of temporal changes in content drawn on the whiteboard 330. Activity occurring near the whiteboard comprises an attendee being close enough to the whiteboard to draw on the whiteboard. In one example embodiment, a distance of two feet or less from the whiteboard serves as near enough to the whiteboard to trigger the camera to provide zoomed in images of the whiteboard. Still further, detection of actual drawing on the whiteboard may trigger the camera to provide zoomed in images of the whiteboard.

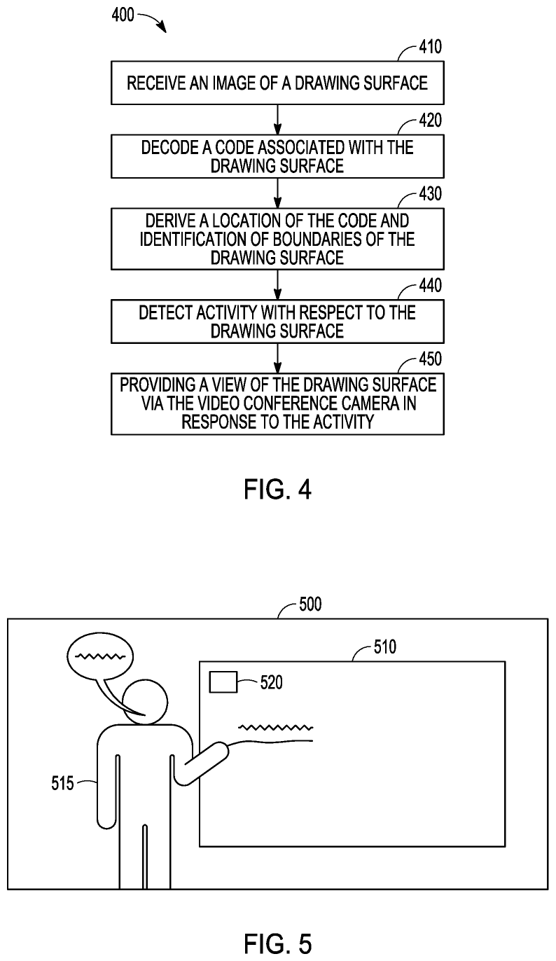

FIG. 4 is a flowchart illustrating a computer implemented method 400 of controlling the camera to provide images of a drawing surface. Method 400 starts at operation 410 by receiving an image of a portion of a room having a drawing surface via a video conference camera. A code associated with the drawing surface is decoded at operation 420 to derive information identifying a location of boundaries of the drawing surface with respect to the code. The code may be located on or near a corner of the drawing surface.

Activity with respect to the drawing surface is detected at operation 430. At operation 440, video feed including a view of the drawing surface is provided via the video conference camera in response to the activity. The view of the drawing surface comprises a camera field of view comprising all of the drawing surface.

The video conference camera in one embodiment includes a 360 degree camera controlled to provide a view of a meeting participant currently talking and to switch the view to the drawing surface in response to the activity.

The code comprises a QR code or a bar code that is either encoded with the information or includes a pointer to the information. The information in one embodiment specifies boundaries of the drawing surface. The boundaries may be specified by one or more vectors specifying a direction and distance from the code itself where the location of the code with respect to the drawing surface is consistently located on, at, in, or near a known corner of the drawing surface. The information may also specify an area on the drawing surface for drawing commands that can be recognized and performed by the system.

For example, if the code is always known to be located in an upper left corner of the drawing surface, the boundaries of a rectangular drawing surface may be identified either by x and y vectors, or a single vector having a direction that corresponds to an opposite corner of the drawing surface.

The code may be located outside the drawing surface in further embodiments, such up a meter or more away from the drawing surface. In such a case, the information may also simply specify an origin for the drawing surface by a first vector or pair of vectors originating at the location of the code. The remaining information would then specify the boundaries from that origin and may include a single vector or a pair of vectors as described above. Precise specification of the location and boundaries of the drawing surface are not needed, as the view of the drawing surface may include an extra margin outside the boundaries to ensure capture of the drawing surface in the view.

FIG. 5 is a block diagram representation of an example rendered video feed view 500 of a whiteboard 510 that includes a person 515 proximate the whiteboard 510. View 500 may be captured by the camera in response to activity being detected near the whiteboard 510 in conjunction with an attendee speaking. The view 500 may be determined by expanding a view of the whiteboard 510 defined by a code 520 to include the recognized person 515 that is speaking. Alternatively, the speaker and whiteboard may be provided in separate views.

In one embodiment, the person 515 that is speaking and detected as being near enough to the whiteboard 510 to be writing or gesturing toward content on the whiteboard may be the activity that trigger the view 500. The view may also be triggered by detecting a change in content being made with the person 515 remaining within a meter or so of the whiteboard, or even obstructing a portion of the view of the whiteboard.

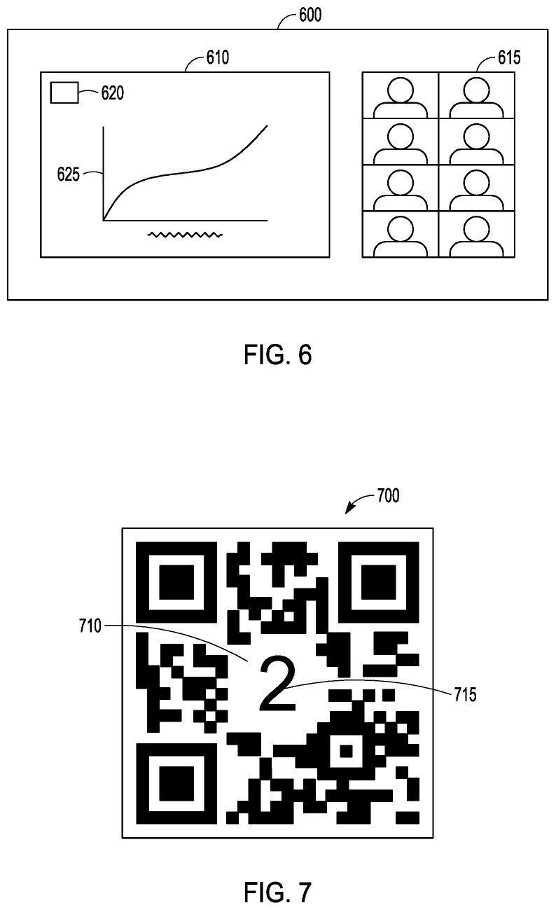

FIG. 6 is a view 600 of a rendered video feed that includes a whiteboard 610 in one window plus a mosaic view of meeting participants 615. Code 620 is used to identify the whiteboard, and changes to content 625 on the whiteboard 620 may be the activity detected that causes the whiteboard view to be created and displayed.

FIG. 7 is a view of a QR code 700 having an empty middle portion 710 for drawing or otherwise placing commands 715 that are recognized by the system for executing pre-defined actions. A “2” is shown in middle portion 710 in FIG. 7. Many other commands may be used. For example, a command 715 of “1” written in the middle portion 710 may be interpreted as an action to save the whiteboard region as page 1 in a meeting attachment to be saved or sent out later. A “2” may specify page 2, or pages may simply be incremented or assigned based on successive copy commands A “C” may be used as a copy command “E” or any other desired symbol may be used to indicate an erase command.

Copied views may be automatically emailed to participants upon execution of the copy command or at a scheduled end of the meeting, or shortly thereafter to account for meetings that run over. The copy command may be used only to copy views into a prearranged storage area or may even be paired with a communication command either at the same time or later to communicate the views to others in the meeting or otherwise specified. Many different types of commands may be used and may be recognized by image recognition and pattern matching. A delay may be used to allow for completion of drawing a command, such as 5 seconds or other desired value.

In a further embodiment, the code, such as bar code, QR code, or other symbol may be decoded to either specify the information or a location, such as a link or address where an area on the drawing surface is for writing commands. Vectors from the code or other means may be used to identify such an area.

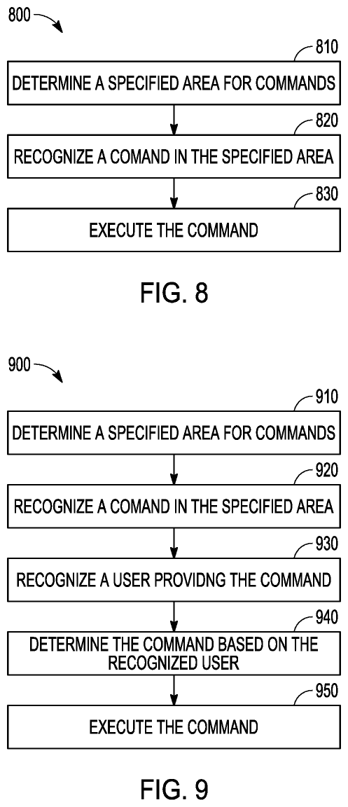

FIG. 8 is a flowchart illustrating a computer implemented method 800 of specifying and executing commands. As described above, the code specifies an area on the drawing surface for writing commands. Method 800 includes determining the specified area for commands at operation 810 and recognizing a command in the specified area at operation 820. At operation 830, the recognized command is executed.

FIG. 9 is a flowchart illustrating a computer implemented method 900 of specifying and executing user configurable commands. As described above, the code specifies an area on the drawing surface for writing commands. Method 900 includes determining the specified area for commands at operation 910 and recognizing a command in the specified area at operation 920. At operation 930, a user is recognized as having provided the command. This may be done by recognizing the voice of a user associated with the drawing surface or even by image recognition of a user in a position, such as within writing distance of the drawing surface and in particular near to the command writing specified area. At least one of a visual or audio acknowledgement may be provided, indicating that the command as been received and has been or will be executed. An option may be provided to specify whether or not to execute the command via gesture, voice, or other user input.

Once the user is recognized, the recognized command may be compared to a user command profile. The user command profile identifies actual commands and actions or operations to be performed based on the recognized command. As such, each user may design command symbols and associated actions or operations. The same command symbol may thus perform different actions or operations based on the user recognized as having provided or drawn the command in the specified area. At operation 950, the determined command is executed.

One example command is a copy command. The copy command identifies actions, such as operations to capture and store a copy of information on the drawing surface. A second command comprises an encrypt and copy command to capture, encrypt, and send a copy of information on the drawing surface to selected recipients. A further command may be “SM” which may be interpreted to mean send to me. A copy of the drawing surface including content will then be taken and sent to the user drawing the command. The email address of the user may be known to the conferencing system or may be obtained from a meeting notice associated with the conference room.

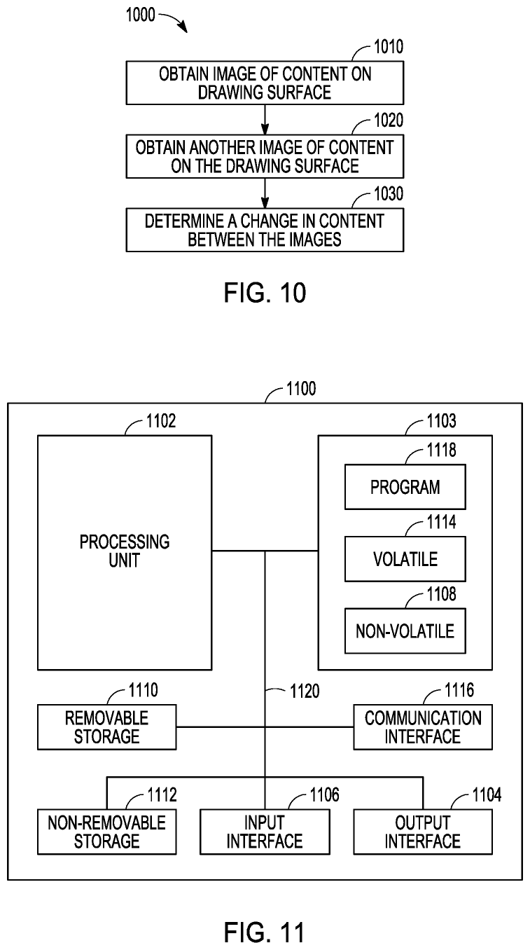

FIG. 10 is a flowchart illustrating a computer implemented method 1000 of detecting activity with respect to a drawing surface. Method 1000 includes obtaining a first image of content on the drawing surface at operation 1010. The first image may include content comprising a blank drawing surface or some actual drawing on the drawing surface. At operation 1020, a second image of content on the drawing surface is obtained. The second image may be obtained a selected amount of time, such as few seconds, every five seconds, every ten seconds, or some other period of time.

At operation 1030, a change between the first image and the second image is determined, resulting in an activity detected signal being generated causing a view of the drawing surface to be provided. A threshold amount of change may be used in some embodiments, or a threshold amount of content added may be used to determine that activity has occurred.

FIG. 11 is a block schematic diagram of a computer system 1100 to drawing surfaces and provide a view of the drawing surfaces in response to detected activity and for performing methods and algorithms according to example embodiments. All components need not be used in various embodiments.

One example computing device in the form of a computer 1100 may include a processing unit 1102, memory 1103, removable storage 1110, and non-removable storage 1112. Although the example computing device is illustrated and described as computer 1100, the computing device may be in different forms in different embodiments. For example, the computing device may instead be a smartphone, a tablet, smartwatch, smart storage device (SSD), or other computing device including the same or similar elements as illustrated and described with regard to FIG. 11. Devices, such as smartphones, tablets, and smartwatches, are generally collectively referred to as mobile devices or user equipment.

Although the various data storage elements are illustrated as part of the computer 1100, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1103 may include volatile memory 1114 and non-volatile memory 1108. Computer 1100 may include—or have access to a computing environment that includes—a variety of computer-readable media, such as volatile memory 1114 and non-volatile memory 1108, removable storage 1110 and non-removable storage 1112. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1100 may include or have access to a computing environment that includes input interface 1106, output interface 1104, and a communication interface 1116. Output interface 1104 may include a display device, such as a touchscreen, that also may serve as an input device. The input interface 1106 may include one or more of a touchscreen, touchpad, mouse, keyboard, camera, one or more device-specific buttons, one or more sensors integrated within or coupled via wired or wireless data connections to the computer 1100, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1100 are connected with a system bus 1120.

Computer-readable instructions stored on a computer-readable medium are executable by the processing unit 1102 of the computer 1100, such as a program 1118. The program 1118 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves to the extent carrier waves are deemed too transitory. Storage can also include networked storage, such as a storage area network (SAN). Computer program 1118 along with the workspace manager 1122 may be used to cause processing unit 1102 to perform one or more methods or algorithms described herein.

### Examples

1. A computer implemented method includes receiving an image of a room having a drawing surface via a video conference camera, decoding a code associated with the drawing surface to derive a location of the code with respect to the drawing surface and identification of a boundary of the drawing surface with respect to the code, detecting activity with respect to the drawing surface, and providing a video feed including a view of the drawing surface via the video conference camera in response to the activity.

2. The method of example 1 wherein the code is located on a corner of the drawing surface.

3. The method of any of examples 1-2 wherein the code specifies an area on the drawing surface for writing commands, the method further including recognizing a command in the specified area and executing the command.

4. The method of example 3 and further comprising recognizing a user writing in the specified area wherein the command is recognized as a function of an identity of the user.

5. The method of any of examples 1˜4 wherein a first command comprises a copy command to capture and store a copy of content on the drawing surface.

6. The method of any of examples 1-5 wherein a second command comprises an encrypt and copy command to capture, encrypt, and send a copy of content on the drawing surface to selected recipients.

7. The method of any of examples 1-6 wherein the video conference camera comprises a 360 degree camera controlled to provide a view of a meeting participant currently talking and to switch the view to the drawing surface in response to the activity.

8. The method of any of examples 1-7 wherein the code comprises a QR code having an internal open space for specifying commands.

9. The method of any of examples 1-8 wherein the code comprises a bar code specifying an area on the drawing surface for specifying commands.

10. The method of any of examples 1-9 wherein the view of the drawing surface comprises a camera field of view comprising all of the drawing surface.

11. The method of any of examples 110 wherein detecting activity with respect to the drawing surface comprises detecting a person in a position to drawn on the drawing surface.

12. The method of any of examples 11 wherein detecting activity with respect to the drawing surface includes obtaining a first image of content on the drawing surface, obtaining a second image of content on the drawing surface, and determining a change between the first image and the second image.

13. A machine-readable storage device has instructions for execution by a processor of a machine to cause the processor to perform operations to perform a method. The operations include receiving an image of a room having a drawing surface via a video conference camera, decoding a code associated with the drawing surface to derive a location of the code with respect to the drawing surface and identification of a boundary of the drawing surface with respect to the code, detecting activity with respect to the drawing surface, and providing a video feed including a view of the drawing surface via the video conference camera in response to the activity.

14. The device of example 13 wherein the code specifies an area on the drawing surface for writing commands, the operations further including recognizing a command in the specified area and executing the command.

15. The device of example 14 wherein the operations further comprise recognizing a user writing in the specified area wherein the command is recognized as a function of an identity of the user.

16. The device of any of examples 13-15 wherein a first command comprises at least one of copy command to capture and store a copy of content on the drawing surface and an encrypt and copy command to capture, encrypt, and send a copy of content on the drawing surface to selected recipients.

17. The device of any of examples 13-16 wherein detecting activity with respect to the drawing surface comprises detecting a person in a position to drawn on the drawing surface.

18. The device of any of examples 13-17 wherein detecting activity with respect to the drawing surface includes obtaining a first image of content on the drawing surface, obtaining a second image of content on the drawing surface, and determining a change between the first image and the second image.

19. A device includes a processor and a memory device coupled to the processor and having a program stored thereon for execution by the processor to perform operations. The operations include receiving an image of a room having a drawing surface via a video conference camera, decoding a code associated with the drawing surface to derive a location of the code with respect to the drawing surface and identification of a boundary of the drawing surface with respect to the code, detecting activity with respect to the drawing surface, and providing a video feed including a view of the drawing surface via the video conference camera in response to the activity.

20. The device of example 19 wherein the code specifies an area on the drawing surface for writing commands, the operations further including recognizing a command in the specified area and executing the command, wherein the commands include at least one of a copy command to capture and store a copy of content on the drawing surface and an encrypt and copy command to capture, encrypt, and send a copy of content on the drawing surface to selected recipients.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving an image of a room having a drawing surface via a video conference camera;
decoding a code associated with the drawing surface to derive a location of the code with respect to the drawing surface and identification of a boundary of the drawing surface with respect to the code;
detecting activity with respect to the drawing surface; and
providing a video feed including a view of the drawing surface defined by the boundary via the video conference camera in response to the activity.

2. The method of claim 1 wherein the code is located on a corner of the drawing surface.

3. The method of claim 1 wherein the code specifies an area on the drawing surface for writing commands, the method further comprising:
recognizing a command in the specified area; and
executing the command.

4. The method of claim 3 and further comprising recognizing a user writing in the specified area wherein the command is recognized as a function of an identity of the user.

5. The method of claim 1 wherein a first command comprises a copy command to capture and store a copy of content on the drawing surface.

6. The method of claim 1 wherein a second command comprises an encrypt and copy command to capture, encrypt, and send a copy of content on the drawing surface to selected recipients.

7. The method of claim 1 wherein the video conference camera comprises a 360 degree camera controlled to provide a view of a meeting participant currently talking and to switch the view to the drawing surface in response to the activity.

8. The method of claim 1 wherein the code comprises a QR code having an internal open space for specifying commands.

9. The method of claim 1 wherein the code comprises a bar code specifying an area on the drawing surface for specifying commands.

10. The method of claim 1 wherein the view of the drawing surface comprises a camera field of view comprising all of the drawing surface.

11. The method of claim 1 wherein detecting activity with respect to the drawing surface comprises detecting a person in a position to drawn on the drawing surface.

12. The method of claim 1 wherein detecting activity with respect to the drawing surface comprises:
obtaining a first image of content on the drawing surface;
obtaining a second image of content on the drawing surface; and
determining a change between the first image and the second image.

13. A machine-readable storage device having instructions for execution by a processor of a machine to cause the processor to perform operations to perform a method, the operations comprising:
receiving an image of a room having a drawing surface via a video conference camera,
decoding a code associated with the drawing surface to derive a location of the code with respect to the drawing surface and identification of a boundary of the drawing surface with respect to the code;
detecting activity with respect to the drawing surface; and
providing a video feed including a view of the drawing surface defined by the boundary via the video conference camera in response to the activity.

14. The device of claim 13 wherein the code specifies an area on the drawing surface for writing commands, the operations further comprising:
recognizing a command in the specified area; and
executing the command.

15. The device of claim 14 wherein the operations further comprise recognizing a user writing in the specified area wherein the command is recognized as a function of an identity of the user.

16. The device of claim 13 wherein a first command comprises at least one of:
a copy command to capture and store a copy of content on the drawing surface; and
an encrypt and copy command to capture, encrypt, and send a copy of content on the drawing surface to selected recipients.

17. The device of claim 13 wherein detecting activity with respect to the drawing surface comprises detecting a person in a position to drawn on the drawing surface.

18. The device of claim 13 wherein detecting activity with respect to the drawing surface comprises:
obtaining a first image of content on the drawing surface;
obtaining a second image of content on the drawing surface; and
determining a change between the first image and the second image.

19. A device comprising:
a processor; and
a memory device coupled to the processor and having a program stored thereon for execution by the processor to perform operations comprising:
receiving an image of a room having a drawing surface via a video conference camera;
decoding a code associated with the drawing surface to derive a location of the code with respect to the drawing surface and identification of a boundary of the drawing surface with respect to the code;
detecting activity with respect to the drawing surface; and
providing a video feed including a view of the drawing surface defined by the boundary via the video conference camera in response to the activity.

20. The device of claim 19 wherein the code specifies an area on the drawing surface for writing commands, the operations further comprising:
recognizing a command in the specified area; and
executing the command, wherein the commands include at least one of:
a copy command to capture and store a copy of content on the drawing surface; and
an encrypt and copy command to capture, encrypt, and send a copy of content on the drawing surface to selected recipients.
